(19) United States
(12) Patent Application Publication
(10) Pub. No.: US 2007/0049115 A1
(43) Pub. Date: Mar. 1, 2007

(54) Electrical Connector

(76) Inventors: Isao Igarashi, Tokyo (JP); Shinsaku Toda, Kanagawa (JP)

Correspondence Address: BARLEY SNYDER, LLC, 1000 WESTLAKES DRIVE, SUITE 275, BERWYN, PA, 19312, US

(21) Appl. No.: 11/461,836

(22) Filed: Aug. 2, 2006

(30) Foreign Application Priority Data
Aug. 26, 2005 (JP) 2005-245508

(51) Int. Cl. H01R 13/648

(52) U.S. Cl. 439/607

(57) ABSTRACT

An electrical connector comprises a plug and a receptacle. The receptacle has an insulative housing with a protruding member having elastic contacts for signal and non-elastic contacts for power supply disposed thereon, wherein the non-elastic contacts are disposed on surfaces orthogonal to surfaces on which the elastic contacts are disposed. The plug has an insulative housing with an interior surface having elastic contacts for power supply and non-elastic contacts for signal disposed thereon, wherein the non-elastic contacts are disposed on surfaces orthogonal to surfaces on which the elastic contacts are disposed. A chamfered edge is provided on the plug and the receptacle such that either the plug or a conventional USB-standard B-plug can be received in the receptacle.

### FIELD OF THE INVENTION

The present invention relates to an electrical connector for transmitting signals, and in particular relates to an electrical connector conforming to Universal Serial Bus (USB) or other standards.

### BACKGROUND OF THE INVENTION

Several standards have been established for electrical connectors used to connect together an information-processing device having a host function (hereinafter referred to as a host device) as typified by a personal computer and an information-processing device not having a host function (hereinafter referred to simply as a peripheral device), such as the peripheral device of a personal computer. Of such standards, FIGS. 4(A)-5(B) show the configurations of conventional connectors based on the widely used USB standard (see FIGS. 8-9 of Unexamined Patent Application Publication JP2003-045582A). FIGS. 4(A)-4(B) show an example of a conventional USB-standard A-plug used for a connection on the host device (upstream) side. Moreover, FIG. 5(A) shows a conventional USB-standard B-receptacle for a connection on the peripheral device (downstream) side, wherein FIG. 5(B) illustrates a conventional USB-standard B-plug.

Among USB connectors, a USB-standard A-receptacle and a USB-standard A-plug that accepts the USB-standard A-receptacle, which are used for connections on the host device side, are equipped with power supply contacts for supplying electric power from the host device to the peripheral device. For example, a peripheral device such as a mouse or a keyboard configured to connect to a host device via only a USB-standard A-connector, operates even if not equipped with its own power supply by simply connecting an A-plug to the USB port of the host device.

On the other hand, among USB connectors, a USB-standard B-receptacle and a USB-standard B-plug are not equipped with power supply contacts. USB-standard B-connectors are normally used to connect peripheral devices such as a printer, scanner or disk drive, which use a commercial power supply because they consume relatively large amounts of electric power, to a host device via a separate cable.

However, with some peripheral devices connected by a USB-standard B-connector, it is desired to transmit signals to and from another device directly, without passing though a host device such as a personal computer. In this case, because one of the peripheral devices must function as a host device, it is necessary to be able to transmit a voltage between the relevant peripheral devices to activate the host function.

FIGS. 6(A)-6(B) show an example of a receptacle 400 that complies with the USB standard and was previously proposed to realize the above described mode of usage of a peripheral device (see FIG. 3 of Unexamined Patent Application Publication JP2002-163051A). The receptacle 400 has a basic configuration that is common to the USB-standard B-receptacle and is capable of accepting the USB-standard B-plug in exactly the same manner as the USB-standard B-receptacle. The receptacle 400 is also capable of accepting a plug 500 that conforms to the USB standard.

As shown in FIG. 6(B), the receptacle 400 is provided with an insulative housing 410 having nearly the same shape as the insulative housing of the USB-standard B-receptacle that accepts the USB-standard B-plug. The insulative housing 410 has a recessed mating member 410a that opens into a substantially rectangular shape and a cuboid-shaped protruding member 411 formed in a center of the recessed mating member 410a. Chamfered portions K1, K2 are formed at upper left and right corners of the recessed mating member 410a and act as keys for regulating the insertion orientation of the plug 500.

The receptacle 400 includes elastic contacts T for transmitting signals to and from the plug 500 and power supply pin sockets C1, C2 for transmitting a control voltage to the plug 500. The elastic contacts T are disposed at opposing positions on upper and lower surfaces of the protruding member 411. Two of the elastic contacts T are disposed on each of the upper and lower surfaces. The receptacle 400 is additionally configured with two of the power supply pin sockets C1, C2, which are not provided on the USB-standard B-receptacle. The power supply pin sockets C1, C2 are disposed on an anterior surface of the protruding member 411 so that a power supply voltage can be transmitted to the plug 500 accepted into the insulative housing 410. In other words, the receptacle 400 differs from the USB-standard B-receptacle in that it is provided with a connector for outputting a voltage. The receptacle 400 may therefore be considered to be a USB-standard B-receptacle to which power supply contacts have been added.

FIGS. 7(A)-(C) show an example of the plug 500 (see FIG. 4 of Unexamined Patent Application Publication JP2002-163051A). The plug 500 is configured such that signals can be transmitted to and from the receptacle 400 and such that a voltage output from the power supply pin sockets C1, C2 provided on the receptacle 400 can be received. The plug 500 comprises an insulative housing 510 that mates with the insulative housing 410 of the receptacle 400. A tip of the insulative housing 510 constitutes a mating portion that is accepted by the receptacle 400 and a rectangular recessed member 510a that accepts the protruding member 411 of the insulative housing 410 on the mating face is formed as a square tubular shape. Beveled portions L1, L2 are formed, respectively, at upper left and right ridges of the square tubular shaped mating portion so as to prevent interference from the chamfered portions K1, K2 of the recessed mating member 410a of the receptacle 400. The plug 500 includes non-elastic contacts S that contact each of the elastic contacts T of the receptacle 400 for the purpose of transmitting signals and power receiving pins P1, P2 for receiving a voltage from the pin sockets C1, C2 of the receptacle 400.

As described above, although the plug 500 shares a common basic configuration with that of the USB-standard B-plug, the plug 500 is not interchangeable with the USB-standard B-plug because of the two power receiving pins P1, P2, disposed at a center of the recessed member 510a and protruding from a bottom thereof toward the mating face. In other words, if an attempt is made to insert the plug 500 into the USB-standard B-receptacle, the two protruding power receiving pins P1, P2 inside the recessed member 510a will collide with the protruding member inside the insulative housing of the USB-standard B-receptacle.

Since the receptacle 400 and the plug 500 are both provided with power supply contacts, the combination thereof enables signals to be transmitted in the same manner as the combination of the USB-standard B-receptacle and the USB-standard B-plug and also enables power to be transmitted. Furthermore, the receptacle 400 conforms to the USB standard such that in addition to accepting the plug 500 provided with power supply contacts, the receptacle 400 is also capable of accepting the USB-standard B-plug, which is not provided with power supply contacts.

However, because the USB standard defines the four signal contacts disposed at the protruding member inside the recessed mating member of the USB-standard B-receptacle as elastic contacts, a space must be maintained inside the protruding member 411 of the receptacle 400 to permit displacement of each of the signal contacts. Thus, proper positioning of the power supply pin sockets C1, C2 is difficult. Moreover, because voltage-receiving pins P1, P2 inside the insulative housing of the plug 500 protrude toward the mating face, not only is there a lack of interchangeability with the USB-standard B-plug, but if the plug 500 is accidentally inserted into the USB-standard B-receptacle, the voltage-receiving pins P1, P2 will collide with the protruding member inside the recessed mating member of the USB-standard B-receptacle and may be damaged or may be caused to short-circuit.

### BRIEF SUMMARY OF THE INVENTION

It is an object of the present invention to provide a receptacle and a plug that are equipped with power supply contacts such that incorrect mating does not result in an unintended combination.

This and other objects are achieved by an electrical connector comprising a plug and a receptacle. The plug has an insulative housing with a recessed member configured for receiving a protruding member of the receptacle and a non-elastic contact and an elastic contact are disposed along an interior surface of the insulative housing along a direction of insertion of the plug into the receptacle, wherein the interior surface of the non-elastic contact is substantially orthogonal to the interior surface of the elastic contact. The receptacle has an insulative housing with a recessed mating member configured for receipt of the plug, a protruding member disposed inside the recessed mating member that extends toward a mating face of the receptacle, and an elastic contact and a non-elastic contact disposed along an outer surface of the protruding member along a direction of insertion of the plug into the receptacle, wherein the outer surface with the elastic contact is substantially orthogonal to the outer surface with the non-elastic contact.

This and other objects are further achieved by a plug of an electrical connector comprising an insulative housing with a recessed member configured for receiving a protruding member of a receptacle. At least one non-elastic contact is disposed along an interior surface of the insulative housing along a direction of insertion of the plug into the receptacle. At least one elastic contact is disposed along the interior surface of the insulative housing along a direction of insertion of the plug into the receptacle, wherein the interior surface of the non-elastic contact is substantially orthogonal to the interior surface of the elastic contact.

This and other objects are still further achieved by a receptacle of an electrical connector comprising an insulative housing with a recessed mating member configured for receipt of a plug and a protruding member disposed inside the recessed mating member that extends toward a mating face of the receptacle. At least one elastic contact is disposed along an outer surface of the protruding member along a direction of insertion of the plug into the receptacle. At least one non-elastic contact is disposed along the outer surface of the protruding member along a direction of insertion of the plug into the receptacle, wherein the outer surface with the elastic contact is substantially orthogonal to the outer surface with the non-elastic contact.

### BRIEF DESCRIPTION OF THE DRAWINGS

FIG. 1(A) is a plan view of a mating face of a receptacle according to an embodiment of the invention;

FIG. 1(B) is a sectional view taken along line A-A of FIG. 1(A);

FIG. 1(C) is a sectional view taken along line B-B of FIG. 1(A);

FIG. 2(A) is a plan view of a mating face of a plug according to an embodiment of the invention;

FIG. 2(B) is a sectional view taken along line A-A in FIG. 2(A);

FIG. 3(A) is a schematic illustration of the receptacle mated with the plug;

FIG. 3(B) is a schematic illustration of the receptacle mated with a USB-standard B-plug;

FIG. 4(A) is a plan view of a mating face of a conventional USB-standard A-plug;

FIG. 4(B) is a plan view of the conventional USB-standard A-plug;

FIG. 5(A) is a plan view of a mating face of a conventional USB-standard B-receptacle;

FIG. 5(B) is a plan view of a conventional USB-standard B-plug;

FIG. 6(A) is a plan view of a mating face of a receptacle according to the prior art that receives electric power from a plug that conforms to the USB-standard B-plug;

FIG. 6(B) is a sectional view taken along line A-A in FIG. 6(A);

FIG. 6(C) is a sectional view taken along line B-B in FIG. 6(A);

FIG. 7(A) is a plan view of a mating face of a plug according to the prior art that supplies electric power to a receptacle that conforms to the USB-standard B-receptacle;

FIG. 7(B) is a sectional view taken along line A-A in FIG. 7(A); and

FIG. 7(C) is a sectional view taken along line B-B in FIG. 7(A).

### DETAILED DESCRIPTION OF THE INVENTION

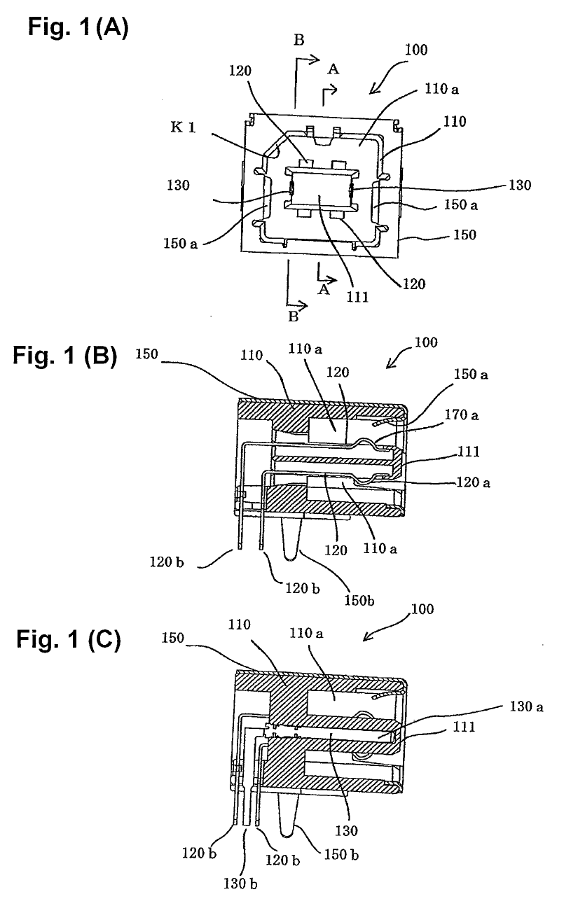

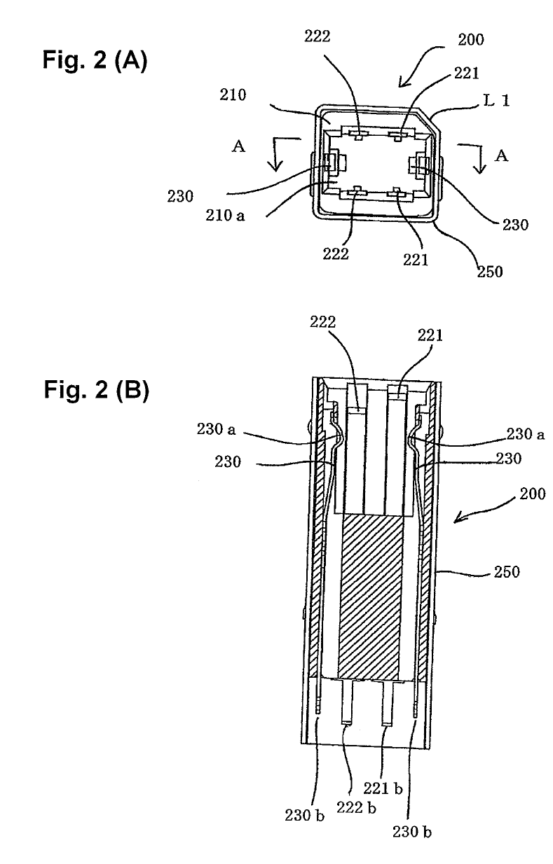

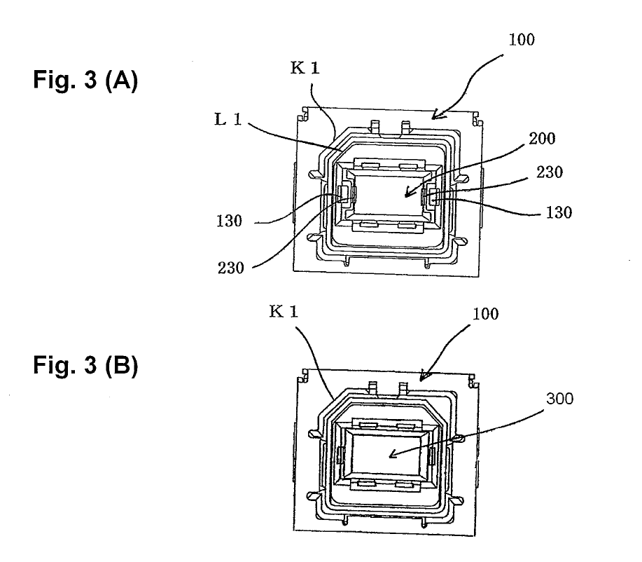

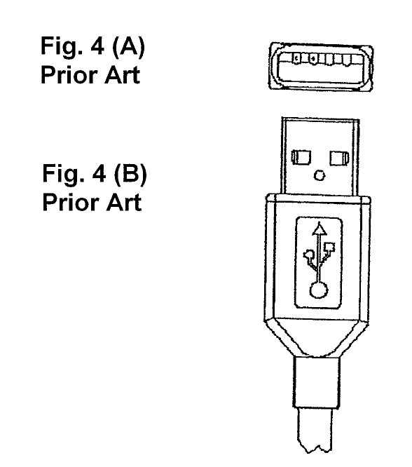

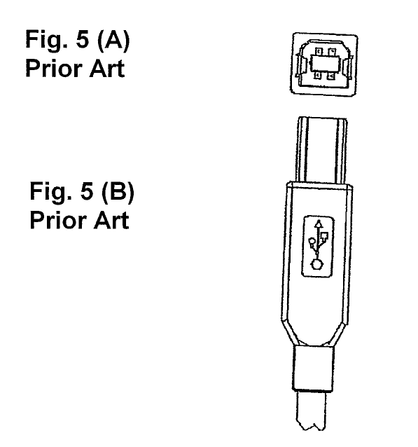

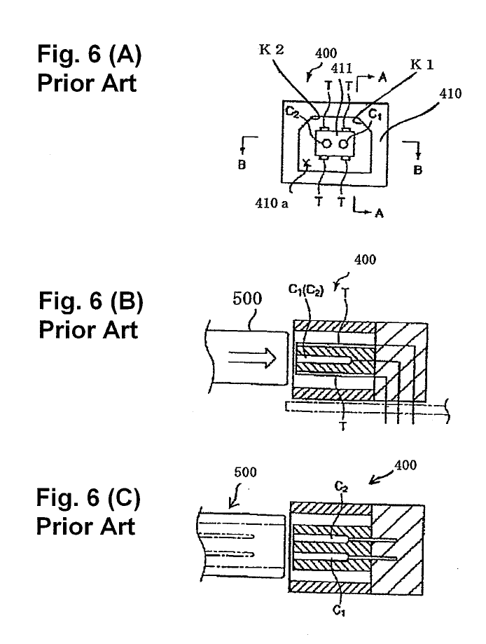

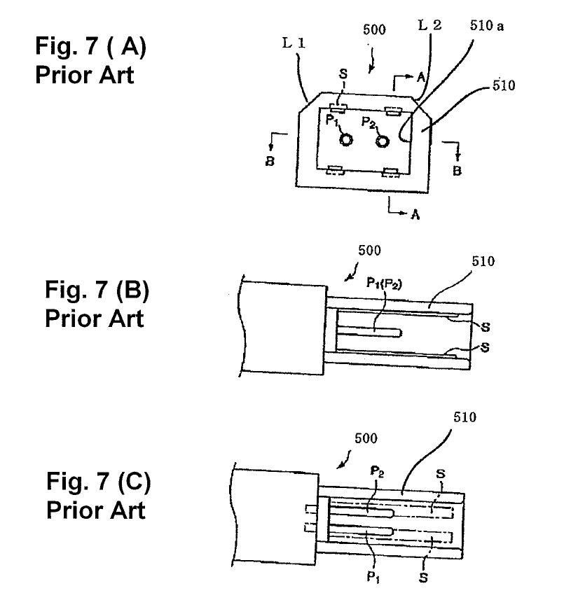

An electrical connector according to the invention comprises a receptacle 100 according to an embodiment of the present invention (FIGS. 1(A)-1(C)) capable of mating with either a plug 200 according to an embodiment of the present invention (FIGS. 2(A)-2(B)) or a USB-standard B-plug 300 (FIGS. 5(A) and 3(B)).

FIGS. 1(A)-1(C) show the receptacle 100 according to an embodiment of the present invention. As shown in FIG. 1(A), the receptacle 100 comprises an insulative housing 110 formed with substantially the same shape as an insulative housing of a USB-standard B-receptacle (FIGS. 5(A) and 3(B)). The insulative housing 110 has a recessed mating member 110a that opens into a substantially rectangular shape. A substantially cuboid protruding member 111 is formed in an approximate center of the recessed mating member 110a and protrudes toward a mating face thereof. Formed at an upper left corner of the recessed mating member 110a is a chamfered portion K1 that acts as a key for regulating the insertion orientation of the plug 200 (FIGS. 2(A)-2(B)). Consequently, the receptacle 100 can easily be distinguished from a USB-standard B-receptacle according to the shape of the opening part.

Elastic contacts 120 are disposed at opposing positions on an outer surface of the protruding member 111. The elastic contacts 120 may be, for example, signal contacts. In the illustrated embodiment, two of the elastic contacts 120 are disposed on an upper surface and two of the elastic contacts 120 are disposed on a lower surface. As shown in FIG. 1(B), the elastic contacts 120 are arranged in a cavity inside the protruding member 111 along the outer surface and extend in a direction of insertion and/or extraction. The elastic contacts 120 are disposed such that a contact area 120a bent into a substantially convex shape near a tip thereof protrudes slightly outward from the outer surface of the protruding member 111. The contact area 120a protrudes slightly outward from an outer surface of the protruding member 111 due to the elasticity of the elastic contact 120. When mated with the plug 200, engagement with signal contacts of the plug 200 (FIGS. 2(A)-2(B)) with an area 170a causes the contact area 120a to be displaced toward an interior surface of the protruding member 111 such that contact with the signal contacts of the plug 200 is elastically maintained. An end portion of each of the elastic contacts 120 extending toward a side of the insulative housing 110 opposite from the contact area 120a passes through a bottom surface of the recessed mating member 110a. Each of the end portions has a soldering member 120b that protrudes outward from the insulative housing 110 and is soldered to a circuit board (not shown).

As shown in FIGS. 1(A)-1(C), non-elastic contacts 130, which are not provided in the USB-standard B-receptacle (FIGS. 5(A) and 3(B)), are provided on the outer surface of the protruding member 111. The non-elastic contacts 130 are not shown in FIG. 1(B). The non-elastic contacts 130 may be, for example, power supply contacts for supplying electric power to the plug 200 (FIGS. 2(A)-2(B)) that has been received in the insulative housing 110. In the illustrated embodiment, one of the non-elastic contacts 130 is disposed on a left side surface of the protruding member 111, and one of the non-elastic contacts 130 is disposed on a right side surface of the protruding member 111. When simple plate-shaped non-elastic contacts 130 extending in the direction of insertion and/or extraction are disposed in this area, there is no need to make the external shape of the protruding member 111 substantially different from that of a protruding member of the USB-standard B-receptacle (FIGS. 5(A) and 3(B)). The side surfaces of the protruding member 111 of the receptacle 100 are formed with a slightly recessed shape so that the external shape of the protruding member 111, including the non-elastic contacts 130, corresponds to the external shape of the protruding member in the recessed mating member of the USB-standard B-receptacle (FIGS. 5(A) and 3(B)) and also guides a power-receiving contact 230 of the plug 200 (FIGS. 2(A)-2(B)). An end portion of each of the non-elastic contacts 130 extending toward a side of the insulative housing 110 opposite from a contact area 130a passes through the bottom surface of the recessed mating member 110a. Each of the end portions has a soldering member 130b that protrudes outward from the insulative housing 110 and is soldered to a circuit board (not shown).

The non-elastic contacts 130 have a simple plate shape and therefore are not displaced when mating with the plug 200 (FIGS. 2(A)-2(B)). Moreover, because the non-elastic contacts 130 are disposed at the right and left surfaces of the protruding member 110, which has a substantially rectangular cross-section, the non-elastic contacts 130 are disposed substantially orthogonal to the surfaces at which the elastic contacts 120 of the receptacle 100 are disposed. Consequently, the addition of the non-elastic contacts 130 enables the cavity inside the protruding member 111 to be used as a space allowing for sufficient elastic displacement of the elastic contacts 120 when mating with the plug 200 (FIGS. 2(A)-2(B)), without requiring changes in the arrangement of the elastic contacts 120.

As shown in FIGS. 1(A)-1(C), an exterior of the insulative housing 110 is covered with a shield 150. The shield 150 has a tongue 150a adjacent a mating face of the receptacle that extends into the recessed mating member 110a, as shown in FIG. 1(B). The tongue 150a acts as a spring for holding the plug 200 (FIGS. 2(A)-2(B)) elastically when received in the recessed mating member 110a. Moreover, an attachment member 150b protrudes from the bottom surface of the insulative housing 110 at an edge of the shield 150 for mounting this receptacle 100 onto the circuit board (not shown).

As shown in FIGS. 2(A)-2(B), the plug 200 corresponds to the receptacle 100 and is configured such that signals can be transmitted to and from the receptacle 100 and that electric power can be received from the non-elastic contacts 130 provided on the receptacle 100. As shown in FIG. 2(A), the plug 200 comprises an insulative housing 210 configured to mate with the insulative housing 110 of the receptacle 100. A tip of the insulative housing 210 constitutes a mating portion that is received by the receptacle 100. A substantially cuboidal recessed member 210a that is configured to receive the protruding member 111 at the mating face of the receptacle 100 opens into a substantially rectangular shape. A beveled portion L1 that functions as a key is formed on an upper right ridge of the recessed member 210a so as to prevent interference from the chamfered portion K1 of the recessed mating member 110a of the receptacle 100. An exterior of the insulative housing 210 is covered with a shield 250.

Pairs of non-elastic contacts 221, 222 are disposed in opposing positions on upper and lower surfaces along an interior surface of the insulating housing 210 so as to make contact with the elastic contacts 120 disposed on the upper and lower side surfaces of the protruding member 111, respectively. The non-elastic contacts 221, 222 may be, for example, signal contacts. The non-elastic contacts 221, 222 are plate-shaped and extend in a direction of insertion and/or extraction. The non-elastic contacts 221 are disposed a different distance from a mating face than the non-elastic contacts 222, as shown in FIG. 2(B). This arrangement satisfies the specifications relating to hot swapping, as specified by USB standards. An end portion of each of the non-elastic contacts 221, 222 has a soldering member 221b, 222b, respectively for soldering to a circuit board (not shown).

The interior surface of the insulative housing 210 is additionally provided with a pair of elastic contacts 230, which are not provided on the USB-standard B-plug (FIG. 5(B)). The elastic contacts 230 may be, for example, power supply contacts for receiving electric power from the non-elastic contacts 130 of the receptacle 100. As shown in FIG. 2(B), the elastic contacts 230 are disposed on the interior surface of the insulative housing 210. One of the elastic contacts 230 is disposed on a left side surface of the insulative housing 210 where the non-elastic contacts 221, 222 are not located and one of the elastic contacts 230 is disposed on a right side surface of the insulative housing 210 where the non-elastic contacts 221, 222 are not located. The elastic contacts 230 extend in the direction of insertion and/or extraction along the interior surface of the insulative housing 210 and are disposed such that a contact area 230a bent into a substantially convex shape near a tip thereof protrudes slightly from the interior surface into the recessed member 210a. The contact area 230a protrudes slightly outward from the interior surface of the insulative housing 210 due to the elasticity of the elastic contact 230. When mated with the receptacle 100, the contact area 230a contacts the non-elastic contacts 130 on the side surfaces of the protruding member 111 and is displaced to elastically maintain contact with the non-elastic contacts 130. An end portion of each of the elastic contacts 230 extending toward a side of the insulative housing 210 opposite the contact area 230a passes through a posterior of the insulative housing 210. Each of the end portions has a soldering member 230b for soldering to the circuit board (not shown).

FIG. 3(A) shows the plug 200 inserted into the receptacle 100. Although the plug 200 has a beveled portion L1 formed on its upper left corner, as viewed from the mating face, the recessed mating member 110a of the receptacle 100 is formed with a chamfered portion K1 on its upper left corner only, and, as a result, insertion into the receptacle 100 is not impeded. The plug 200 mated with the receptacle 100 receives electric power from the non-elastic contacts 130 of the receptacle 100 via the elastic contacts 230. Since the power supply contacts 230 do not protrude inside the recessed member 210a, there is no risk of damage or short-circuiting of the plug 200.

Because the plug 200 is provided with the beveled portion L1 that functions as a key only on the upper right corner of the mating member, as viewed from the mating face, the plug 200 can only be inserted into the receptacle 100 of the present invention. The plug 200 therefore can not be inadvertently inserted into the USB-standard B-receptacle (FIGS. 5(A) and 3(B)), which prevents damage thereto.

FIG. 3(B) shows the USB-standard B-plug 300 inserted into the receptacle 100. Because the USB-standard B-plug 300 is not provided with contacts at positions corresponding to the pair of non-elastic 130 disposed on both sides of the protruding member 110, the receptacle 100 and the USB-standard B-plug 300 can be mated without an adverse impact on signal transmission and the receptacle 100 is configured for signal transmission in a manner equivalent to that of the USB-standard B-receptacle. Furthermore, because a beveled portion is formed on both upper ridges of the insulative housing of the USB-standard B-plug 300, insertion of the USB-standard B-plug 300 into the receptacle 100 is not obstructed. Therefore, when combined with the USB-standard B-plug 300, the receptacle 100 is completely equivalent to the USB-standard B-receptacle.

The receptacle 100 and the plug 200 is preferred in the case where, for example, a peripheral device has been connected to a host device via a cable and one end thereof attached to a B-plug is to be connected wirelessly, and electric power is to supplied from the relevant peripheral device side to a wireless transmission unit for implementing the wireless connection.

The foregoing illustrates some of the possibilities for practicing the invention. Many other embodiments are possible within the scope and spirit of the invention. For example, the receptacle 100 of the present invention has been described as being mounted on a circuit board and being configured to mate horizontally with the plug 200. However, embodiments of the present invention are not limited to this configuration. For example, the receptacle 100 may be mounted on a circuit board so as to mate vertically with the plug 200 or the receptacle 100 may be attached to the end of a cable, and so on. Moreover, the receptacle 100 and the plug 200 does not have to conform to the USB standards. It is, therefore, intended that the foregoing description be regarded as illustrative rather than limiting, and that the scope of the invention is given by the appended claims together with their full range of equivalents.

What is claimed is:

1. A receptacle of an electrical connector, comprising:
an insulative housing with a recessed mating member configured for receipt of a plug and a protruding member disposed inside the recessed mating member that extends toward a mating face of the receptacle;
at least one elastic contact disposed along an outer surface of the protruding member along a direction of insertion of the plug into the receptacle; and
at least one non-elastic contact disposed along the outer surface of the protruding member along a direction of insertion of the plug into the receptacle, the outer surface with the elastic contact being substantially orthogonal to the outer surface with the non-elastic contact.

2. The receptacle of claim 1, wherein the elastic contact is arranged in a cavity inside the protruding member along the outer surface and has a contact area that protrudes outward from the outer surface of the protruding member.

3. The receptacle of claim 1, wherein the elastic contact is a signal contact and the non-elastic contact is a power supply contact.

4. The receptacle of claim 1, wherein the protruding member has a substantially cuboid shape.

5. The receptacle of claim 1, wherein the recessed mating member has a chamfered edge at a corner thereof configured for regulating insertion of the plug.

6. The receptacle of claim 1, further comprising a shield disposed on an exterior of the insulative housing.

7. A plug of an electrical connector, comprising:
an insulative housing with a recessed member configured for receiving a protruding member of a receptacle;
at least one non-elastic contact disposed along an interior surface of the insulative housing along a direction of insertion of the plug into the receptacle; and
at least one elastic contact disposed along the interior surface of the insulative housing along a direction of insertion of the plug into the receptacle, the interior surface of the non-elastic contact being substantially orthogonal to the interior surface of the elastic contact.

8. The plug of claim 7, wherein the elastic contact has a contact area that protrudes outward from the interior surface into the recessed member.

9. The plug of claim 7, wherein the non-elastic contact is a signal contact and the elastic contact is a power supply contact.

10. The plug of claim 7, wherein the recessed member has a substantially cuboid shape.

11. The plug of claim 7, further comprising a shield disposed on an exterior of the insulative housing.

12. The plug of claim 7, wherein the recessed member has a single chamfered edge at a corner thereof configured for regulating insertion of the plug.

13. An electrical connector, comprising:
a plug having an insulative housing with a recessed member configured for receiving a protruding member of a receptacle, at least one non-elastic contact disposed along an interior surface of the insulative housing along a direction of insertion of the plug into the receptacle, and at least one elastic contact disposed along the interior surface of the insulative housing along a direction of insertion of the plug into the receptacle, the interior surface of the non-elastic contact intersecting the interior surface of the elastic contact; and
the receptacle having an insulative housing with a recessed mating member configured for receipt of the plug and a protruding member disposed inside the recessed mating member that extends toward a mating face of the receptacle, at least one elastic contact disposed along an outer surface of the protruding member along a direction of insertion of the plug into the receptacle, and at least one non-elastic contact disposed along the outer surface of the protruding member along a direction of insertion of the plug into the receptacle, the outer surface with the elastic contact being substantially orthogonal to the outer surface with the non-elastic contact.

14. The electrical connector of claim 13, wherein the elastic contact of the receptacle is arranged in a cavity inside the protruding member along the outer surface and has a contact area that protrudes outward from the outer surface of the protruding member.

15. The electrical connector of claim 13, wherein the elastic contact of the plug has a contact area that protrudes outward from the interior surface into the recessed member.

16. The electrical connector of claim 13, wherein the elastic contact of the receptacle is a signal contact and the non-elastic contact of the receptacle is a power supply contact.

17. The electrical connector of claim 13, wherein the elastic contact of the receptacle engages the non-elastic contact of the plug and the elastic contact of the plug engages the non-elastic contact of the receptacle.

18. The electrical connector of claim 13, wherein both the insulating housing of the plug and the receptacle are covered with a shield.

19. The electrical connector of claim 13, wherein the recessed mating member and the recessed member have a chamfered edge at a corner thereof configured for regulating insertion of the plug.

20. The electrical connector of claim 13, wherein the protruding member has a substantially cuboid shape.
